(19) United States
(12) Patent Application Publication
(10) Pub. No.: US 2015/0039464 A1
(43) Pub. Date: Feb. 5, 2015

(54) SYSTEMS AND METHODS FOR EVENT-BASED GIFT GIVING AND RECEIVING

(71) Applicant: Giftvise, Inc., Chicago, IL (US)

(72) Inventors: Adarsh Seetharam, Santa Clara, CA (US); Stephen Augustine Inacker, JR., Chicago, IL (US)

(21) Appl. No.: 14/450,066

(22) Filed: Aug. 1, 2014

Related U.S. Application Data
(60) Provisional application No. 61/861,263, filed on Aug. 1, 2013.

(51) Int. Cl. G06Q 30/06; G06Q 50/00

(52) U.S. Cl. CPC G06Q 30/0633; G06Q 50/01
USPC 705/26.8

(57) ABSTRACT

Online, event-based gift giving and receiving systems and methods eliminate the redundancy of creating a separate registry or wishlist with the same products listed for each life event by using event-based product tags. One or more example embodiments include setting privacy for event-based product tags, setting privacy for each product on a wishlist, filtering wishlists by event-based product tags, searching for event-based product tags, selectively sharing and displaying products for groups, indicating the unavailability of reserved products and automatically re-listing reserved products not received within a determined time period, using event-based product tags with events imported from external sources, providing third party event hosting using event-based product tags, connecting users who received the same gift, and providing product attribute change notifications, among other things.

### BACKGROUND

Giving and receiving the right gift for the right event can sometimes be difficult. Gift givers often spend a great deal of time and effort shopping for someone only to end up giving them a gift they already have, they did not want, or that did not fit the occasion. Numerous online gift registry and wishlist systems have been developed in order to address this problem, however, most are cumbersome and none are able to properly support all life events for which societal norm dictates the giving of a gift product such as, for example, birthdays, bridal showers, weddings, Super Bowl parties, barbeque parties, holidays, and the like.

### SUMMARY

Therefore, there remains a need for a system by which gift products, gift-giving events, and contacts can be collectively and conveniently be managed. Example embodiments in the present disclosure are designed to make it easier to give and receive the right gift for the right event.

One example embodiment of the present disclosure relates to a method for implementation by one or more data processors forming part of at least one computing system, the method including creating a wishlist comprising one or more product items, creating or importing, from a third-party server, one or more calendar events, associating the one or more product items with at least one of the one or more calendar events, or associating the one or more calendar events with at least one of the one or more product items.

According to one example embodiment, the method may include associating two or more product items with at least one of the one or more calendar events, or associating two or more calendar events with at least one of the one or more product items.

According to another example embodiment, the method may include creating a privacy setting for the one or more product items on the wishlist based, at least in part, on the one or more calendar events. The one or products items on the wishlist may be visible to everyone, only individuals invited to the one or more calendar events, one or more select individuals, one or more select groups, or only the creator of the wishlist.

According to one example embodiment, the method may include tagging the one or more products using a tag. The one or more product items may be configured to be filtered by event, by tag, by privacy setting, and sorted by popularity, price, date or promotions. If the one or more calendar events are imported from the social networking service, then an attendee list comprising at least a portion of the attendees to the one or more calendar events imported is generated.

According to one example embodiment, the method may include providing location-based search and notification services for the one or more product items on any wishlist in the user's network. One example embodiment may include providing a product item attribute change notification to a user when a product item attribute comprising price, promotion, availability, or retailer location changes or the event associated with the product item changes, or the product item is removed from the wishlist.

According to one example embodiment, the method may include inviting one or more friends to the one or more calendar events and connecting users who recently received a gift to users who already own the gift. The one or more product items on the wishlist can be curated products.

According to one example embodiment, the method may include reserving the one or more product items on the wishlist. The method may also include indicating unavailability of the reserved product items, and re-listing the reserved product items not purchased within a determined period of time. The method may also include removing a product item from the wishlist upon purchase of the product item.

The wishlist may be created by adding the one ore more product items to the wishlist manually, using a web widget, using a bar code scanner, from another user's wishlist, or by importing at least part of the wishlist from a retailer's website, for example.

One example embodiment of the present disclosure relates to a non-transitory computer program product storing instructions which, when executed by one or more data processors forming part of at least one computing system, result in operations including creating a wishlist comprising one or more product items, creating or importing, from a third party server, one or more calendar events, associating the one or more product items with at least one of the one or more calendar events, or associating the one or more calendar events with at least one of the one or more product items.

According to one example embodiment, the instructions may include associating two or more product items with at least one of the one or more calendar events, or associating two or more calendar events with at least one of the one or more product items. The instructions may also include creating a privacy setting for the one or more product items on the wishlist based, at least in part, on the one or more calendar events.

One example embodiment of the present disclosure relates to a system for event-based gift giving and receiving, the system including means for creating a wishlist comprising one or more product items, means for creating or importing, from a third party server, one or more calendar events, means for associating the one or more product items with at least one of the one or more calendar events, or associating the one or more calendar events with at least one of the one or more product items.

Details of one or more implementations are set forth in the accompanying drawings and in the description below. Further features, aspects, and advantages will become apparent from the description, the drawings, and the claims.

### BRIEF DESCRIPTION OF THE DRAWINGS

FIG. 1 illustrates an overview of an online, event-based gift giving and receiving system, according to one or more example embodiments of the present disclosure;

FIG. 2 is an illustration of an example implementation of the method of event-based gift giving and receiving, according to one or more example embodiments of the present disclosure;

FIG. 3 is an illustration of an example implementation of the method of event-based gift giving and receiving, according to one or more example embodiments of the present disclosure;

FIG. 4 is an illustration of an example implementation of the method of creating an event, according to one or more example embodiments of the present disclosure;

FIG. 5 is an illustration of an example implementation of the method of importing events, according to one or more example embodiments of the present disclosure;

FIG. 6 shows a flow diagram demonstrating the method by which an event-based product tag is created, according to one or more example embodiments of the present disclosure;

FIG. 7 shows a flow diagram demonstrating the method by which the privacy of each product on a wishlist is set, according to one or more example embodiments of the present disclosure;

FIG. 8 shows a flow diagram demonstrating the method by which a wishlist is filtered by an event-based product tag, according to one or more example embodiments of the present disclosure;

FIG. 9 shows a flow diagram demonstrating the method by which a user browses or views a feed sorted by all, individuals, groups, or events, according to one or more example embodiments of the present disclosure;

FIG. 10 shows a flow diagram demonstrating the method by which a product is reserved and purchased, according to one or more example embodiments of the present disclosure;

FIG. 11 shows a flow diagram demonstrating the method by which an event with event-based product tags is created, according to one or more example embodiments of the present disclosure;

FIG. 12 shows a flow diagram demonstrating the method by which a product is received and connections between users receiving the same gift are made, according to one or more example embodiments of the present disclosure;

FIG. 13 shows a flow diagram demonstrating the method by which product attribute change notifications are provided, according to one or more example embodiments of the present disclosure; and

FIG. 14 shows a flow diagram demonstrating the method by which location-based searches and notifications are executed, according to one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The word “exemplary” is used herein to mean “serving as an example, instance, or illustration.” Any embodiment described herein as “exemplary” is not necessarily to be construed as preferred or advantageous over other embodiments. The terms “laptop”, “computer”, “handheld device”, “mobile device”, “wireless device” and “user equipment” as used herein refers to a communication device such as a computer, cellular telephone, smartphone, tablet, netbook, wireless terminal, laptop computer, or other personal communication system (PCS) device. The device may be either mobile or stationary.

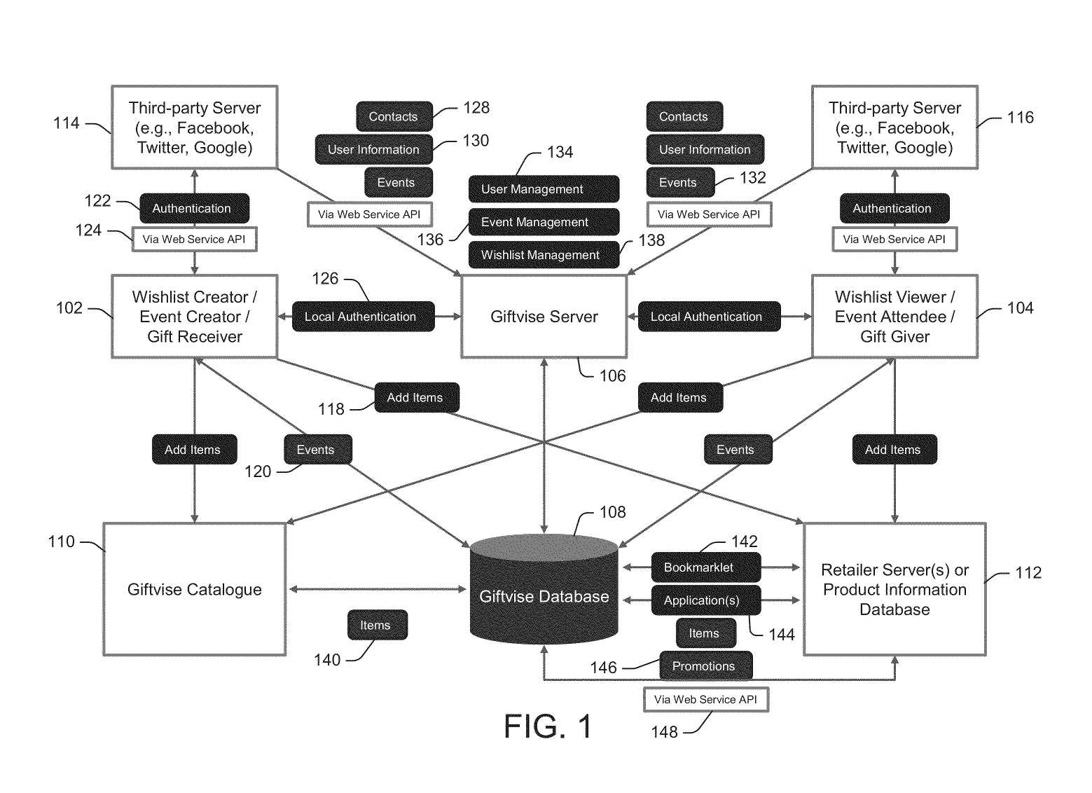

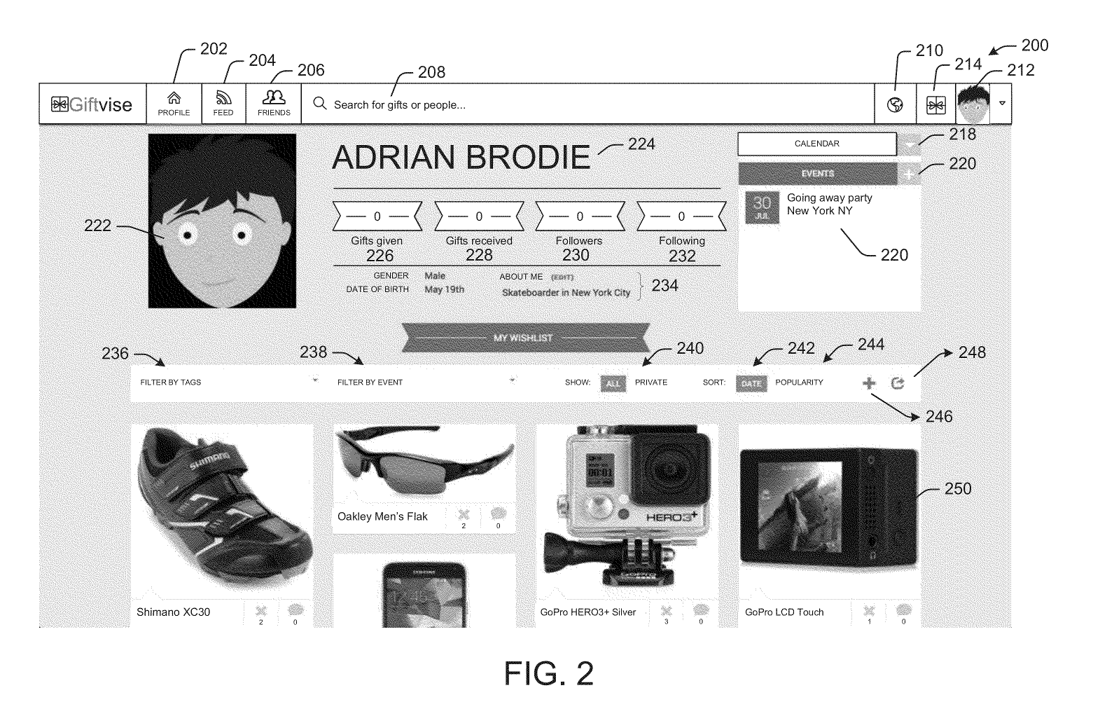

The description below details online, event-based gift giving and receiving system. An overview of the system is shown in FIG. 1, for example, and the more detailed processes occurring within or in conjunction with the system are shown in FIGS. 2-14, for example.

Turning now to the figures, FIG. 1 illustrates an example online, event-based gift giving and receiving system 100, which may serve as a connection point for three parties: a wishlist creator or event creator or gift receiver 102; a wishlist viewer or event attendee or gift giver 104; and one or more retailers/merchants 112. The term “wishlist” as described herein may refer to any list comprising one or more product items a user desires to receive from someone else or gift to someone else.

The wishlist creator or event creator or gift receiver 102 may be referred to hereinafter as a “first user,” the wishlist viewer or event attendee or gift giver 104 may be referred to hereinafter as a “second user,” and the one or more retailers/merchants 112 may be referred to herein as a “retailer.” The first user may use a first user equipment, such as, for example a first computer system, to access the event-based gift giving and receiving system 100, and the second user may use a second user equipment, such as, for example a second computer system, to access the event-based gift giving and receiving system 100. The first and second computer systems may be any type of computer system, such as a personal computer system, which may include a desktop, a laptop computer, a handheld device, mobile device, wireless device, smartphone, tablet, netbook, wireless terminal, or other any personal communication system device. The first and second computer systems may have wired or wireless internet access. The internet access of the first and second computer systems include HTTP (HyperText Transfer Protocol) and may include other protocols as well. For example, the first computer system may use HTTPS (HTTP Secure) to complete a transaction to pay for a gift at the merchant web site. In general, the first and second computer systems may use a web browser (e.g., INTERNET EXPLORER, GOOGLE CHROME, SAFARI, FIREFOX, NETSCAPE, and the like) to interpret content, such as web pages, from the event-based gift giving and receiving system 100.

First user 102 may use local authentication 126 to gain access to the event-based gift giving and receiving system server 106 or may use authentication 122 from a third party server 114 such as, for example, FACEBOOK, TWITTER, GOOGLE, MYSPACE, and the like. If the first user 102 chooses to use local authentication for the first time, the user 102 may be required to register on server 106 by giving information such as, for example, first name, last name, email address, etc. If the first user chooses to use a third party server authentication 122, then such authentication may be enabled using web service application programming interfaces (APIs) 124 to access the website. When a third party server 114 is used for authentication 122, the web service APIs 124 may transfer information such as, for example, user contacts 128, user information 130, such as, name, address, email address, phone number, age, sex, profile picture, etc., and one or more events 132 that may be stored in the user's account on the third party server 114.

User contacts 128 may include a list of individuals or groups, their information, such as, name, address, email address, phone number, age, sex, profile picture, etc. Alternatively, if the first user 102 uses local authentication 126 to gain access to server 106, then the user may add one or more friends already on server 106 such as, for example, a second user or a third user. One or more events 132 that may be transferred from the third party server 114 to server 106 may include calendar events that a user may have stored on the third party server 114. Calendar events 132 may include information about events such as birthdays, weddings, parties, anniversaries, etc. that the user may have stored on the third party server 114. Event information about calendar events 132 may further include event name, event location, event date, event time, event theme, and other details that may be relevant to the event 132.

Once a first user 102 has been authenticated to the access server 106, the first user may create a wishlist by adding items 118 using a local catalogue 110 stored in database 108 or can manually add items using his/her own description. Manually adding a product item to ones wishlist may include providing product information such as, for example, product name, product price, product description, product image, etc. Product items 118 stored in a local catalogue 110 may include one or more curated product items. For example, the catalogue 110 may contain one or more curated product items 118 that may be viewed as popular or trending by some users. Alternatively, expert bloggers or expert product reviewers such as, for example, CNET may contribute to the catalogue based on latest trends, popularity, and/or new market entries.

Alternatively, the first user 102 may add one or more product items to their wishlist in database 108 from a remote server or a product information database 112 belonging to a third party, such as for example, Amazon, Target, Home Depot, Bed Bath & Beyond, Walmart, etc. One example of fetching product information from a third party server or product information database 112 may be for users to use web widgets such as, for example, bookmarklets 142 in their native browsers. Bookmarklets 142 as used herein may refer to an API that may be installed or embedded in a native browser, and may be used to obtain product information or import product information from any third party website to database 108. Alternatively, a user may add product items to his/her wishlist from another user's wishlist, or by importing at least part of the wishlist directly from a retailer's website. Once a product item is transferred or imported to the database 108 using a bookmarlet 142, it becomes a part of catalogue 110, unless a user deletes the product from his/her wishlist. It should be noted, however, that database 108 may receive periodic information about product item 118 from retailer server or product information database 112, and such information may be updated in database 108 periodically.

An alternate method to import product information from a third party server or product information database 112 to local database 108 is to use an application 144 on a computing device such as, for example, a barcode scanner, to scan the barcode attached to a product item 140. Scanning the bar code using the application on the computing device may access the product information database 108 for specific product information such as, for example, product name, product price, product description, product image, merchant location etc. In some instances, the same product may be sold by multiple merchants. In that case, the bar code scanning application may retrieve price or product information from one or more merchants offering such a product, and the user can have an option to choose the merchant of his/her choice. If a merchant is having a promotional sale of the product item desired, then the merchant may also provide promotional information 146 to the database 108 along with the product information. The API may be a web service API 148 or an app on a phone that may have access to both the retailer server or product information database 112 and the local database 108.

“Product item” or “product” as referred to herein may include any product available online, including but not limited to, cameras, camcorders, cell phones, watches, camera lens, sofa sets, movie tickets, event tickets, music CDs, MP3s, video files, audio files, DVDs, BluRay discs, videogames, travel equipment, consumer electronics, bedding material, baby related goods, men's clothing accessories, women's clothing accessories, kids' toys, men's clothing, women's clothing, men's footwear, women's footwear, books, bags, purses, perfumes, colognes, projectors, televisions, musical instruments, surfboards, laptops, tablets, PCs, sunglasses, baby carriers, home furnishings, home furniture, kitchen appliances, store gift cards, electronic gift cards, spirits, etc.

After the first user 102 has added one or more product items 118 to his/her wishlist on server 106, the user 102 may add calendar events to his/her account. Calendar events 120 may include information about events such as birthdays, weddings, parties, anniversaries, etc. Event information about calendar events 120 may include event name, event location, event date, event time, event theme, and other details that may be relevant to the event 120, for example. After the first user 102 has added one or more calendar events to his account on server 106, the user may associate one or more product items 118 to one or more calendar events 120 by using event-based product tagging, which will be described in further detail in later embodiments in the present disclosure.

According to one or more example embodiments, server 106 may be used to execute various tasks such as, for example, user management 134, event management 136, and wishlist management 138. User management 134 may include managing user information for all users that may sign up with system 100. Event management 136 may include managing such as, for example, adding, deleting, modifying, events 120 that may be added by the users of system 100. Wishlist management 138 may include managing, for example, one or more wishlists created by each of the users on server 106, for example.

Similar to the first user 102, a wishlist viewer or event attendee or gift giver 104, who may be referred hereinafter as a “second user” may use local authentication 126 to gain access to the event-based gift giving and receiving system server 106 or may use authentication 122 from a third party server 116 such as, for example, FACEBOOK, TWITTER, GOOGLE, MYSPACE, and the like. Third party server 116 may be the same as server 114 or may be a different third party server. If the second user 104 chooses to use local authentication for the first time, the user 104 may be required to register on server 106 by giving information such as, for example, second name, last name, email address, etc. If the second user chooses to use a third party server authentication 122, then such authentication may be enabled using web service application programming interfaces (APIs) 124 to access the website. When a third party server 116 is used for authentication 122, the web service APIs 124 may transfer information such as, for example, user contacts 128, user information 130, such as, name, address, email address, phone number, age, sex, profile picture, etc., and one or more events 132 that may be stored in the user's account on the third party server 114.

User contacts 128 may include a list of individuals or groups, their information, such as, name, address, email address, phone number, age, sex, profile picture, etc. One or more events 132 that may be transferred from the third party server 116 to server 106 may include calendar events that a user may have stored on the third party server 116. Calendar events 132 may include information about events such as birthdays, weddings, parties, anniversaries, etc. that the user may have stored on the third party server 116. Event information about calendar events 132 may further include event name, event location, event date, event time, event theme, and other details that may be relevant to the event 132.

Once a second user 104 has been authenticated to the access server 106, the second user may access the first user's wishlist and see details of product items that are stored in the first user's wishlist. The second user 104 may select one or more products on the wishlist and complete a purchase transaction on the retailer server 112, for example. A detailed explanation of such a purchase transaction will be described in further detail in later embodiments of the present disclosure.

It should be noted, however, that although database 108 and server 106 are illustrated as separate elements in FIG. 1, it may be apparent to one of skill in the art, that database 108 can be a part of server 106 or vice versa, or they may coexist within the same space.

Turning now to FIG. 2, FIG. 2 is an illustration of an example implementation of a graphical user interface (GUI) 200 for the online gift giving and receiving system 100, according to one or more example embodiments. UI 200 may be an implementation by one or more data processors forming part of at least one computing system, or may be stored on a non-transitory computer program product storing instructions which, when executed by one or more data processors forming part of at least one computing system, result in operations described herein. As illustrated in FIG. 2, UI 200 may include profile 202 of a user, for example, a first user or a second user, which may include user information such as, for example, user name, address, email address, phone number, age, sex, profile picture, etc. UI 200 may include feeds 204 from different users or may include information about products that are trending or popular. Alternatively, feeds 204 may include information about upcoming events on one's calendar or their friend's calendar. UI 200 may also include friends 206 information, which may include a list of friends associated with the user, and may also include a list of friends of friends and friends of friends of friends, for example.

A search bar 208 enables a user to search for product items on the server or people within his/her network. Alternatively, a user can also search for events that may be relates to him/her or search for events that may close by his/her location. UI 200 may include a notification 210 center where a user may be notified when he/she is added by another user as a friend, is invited to an event by his/her friend, or when product items from his/her wishlist have been checked out by a giver 104. UI 200 may also include a link 214 to install a web widget such as, for example, a bookmarklet 142 (as described in FIG. 1), which may enable a user to add items to his/her wishlist from anywhere on the web.

UI 200 may also include user information such as, for example, user name 224, user profile picture 222, the number of gifts given 226 by a user, the number of gifts received 228 by a user, the number of friends following 230 the user, and the number of friends the user is following 232. User information may further include information such as date of birth, sex, and details about the user, which may be displayed in a separate portion 234 of the UI 200.

According to one or more example embodiments, UI 200 may include information about calendar events 120, 132 discussed in FIG. 1. For example, a calendar 218 may highlight events on the calendar itself, or a portion 216 may display upcoming events 220 that may be relevant to the user. Relevant events 220 may include events that the user has been invited to, events that the user has invited his friends to, events that may be occurring in the neighborhood or any other event that may relevant to the user. First user 102 may use button 246 to add one or more product items 250 to his wishlist, for example. Product items 250 may be similar to the product items 120, 132 described with reference to FIG. 1, for example. First user 102 may also share information about the product items 250 in his wishlist with one or more friends using button 248.

Once a user wishlist is populated with one or more product items 250, the user may filter the product items 250 by tags 236, by event 238, by privacy setting 240, and sort by date 242 or by popularity 244. Methods for tagging and creating privacy setting for an event or product will be described in further detail in later embodiments of the disclosure. Privacy of a user's wishlist may be limited to a select few individuals or groups, everyone or no one. If a user's wishlist is shared with no one, then the wishlist is considered to be private and no one else may be able to able to view items or products in that wishlist.

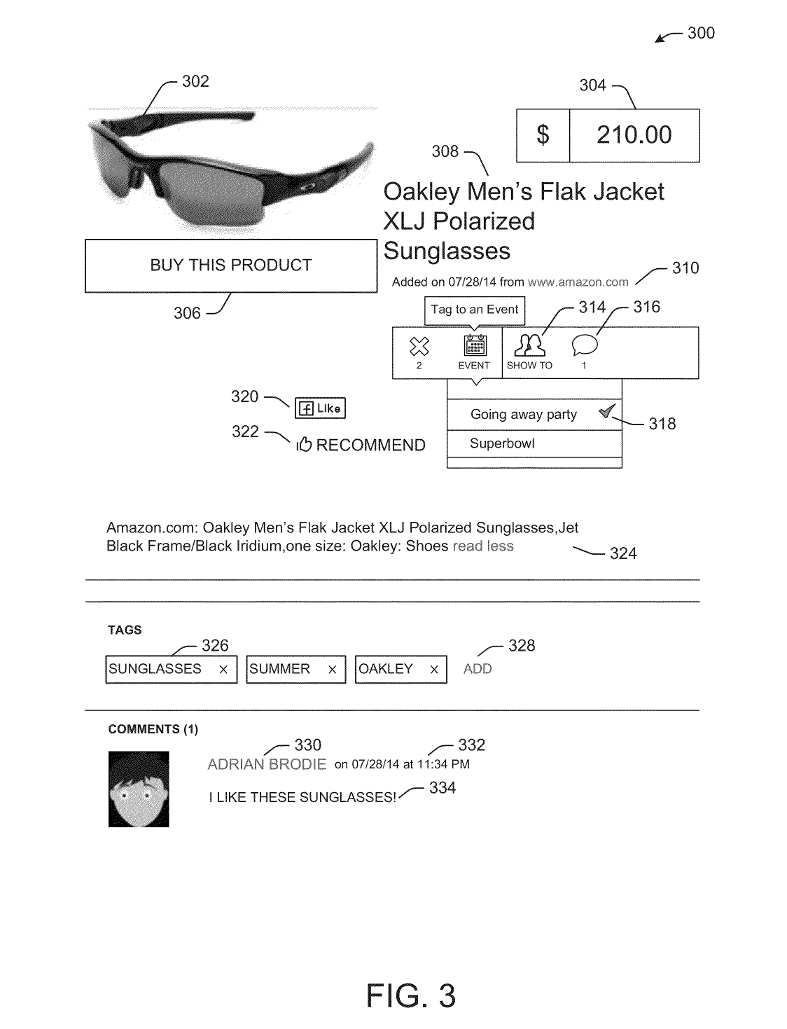

FIG. 3 illustrates an example implementation of a product page, according to one or more example embodiments of the present disclosure, which may be an implementation by one or more data processors forming part of at least one computing system, or may be stored on a non-transitory computer program product storing instructions which, when executed by one or more data processors forming part of at least one computing system, result in operations described herein. As shown in FIG. 3, an instance of a product information page 300 for a product item 250 on a user's wishlist may include product information, such as for example, product name 308, product price 304, product image 302, a link to purchase the product 306, and information 310 about a third party website/server from where the product is sourced. On the product information page 300, for example, a user may tag 312 the product item 250 to a particular event 318 by selecting from a plurality of events on the user's calendar. The method for event-based tagging of product items is described in further detail in later embodiments of the present disclosure. On the product information page 300, for example, a user may also create privacy setting 314 for the product item 250. For example, the user may make the product item 250 visible to everyone, or a select few individuals, a select few groups, or no one. If the user chooses the last option, then the product item 250 may not be visible to anyone other than the user. Product information page 300 may also include comments 316 from the user or other users, and information about the number of users who have added this particular product to their wishlist. According to one example embodiment, a user may also like the product page 300 using a like button 320, for example, or recommend the product 250 to a friend using button 322. The product information page 300 may also include detailed information 324 about the product item 250 such as, for example, technical specifications, shipping details, etc.

A user viewing product information page 300 may tag one or more product items 250 using tags 326 and associating the product item 250 with unique identifiers such as terms that may be relevant to that product. The user may have an option to add one or tags to every product item 250 on his/her wishlist. In a comments section of the product information 300, for example, a user 330 may publish his/her comments 334, and such comments may be published privately or publicly as desired by the user commenting on the product item 250, for example.

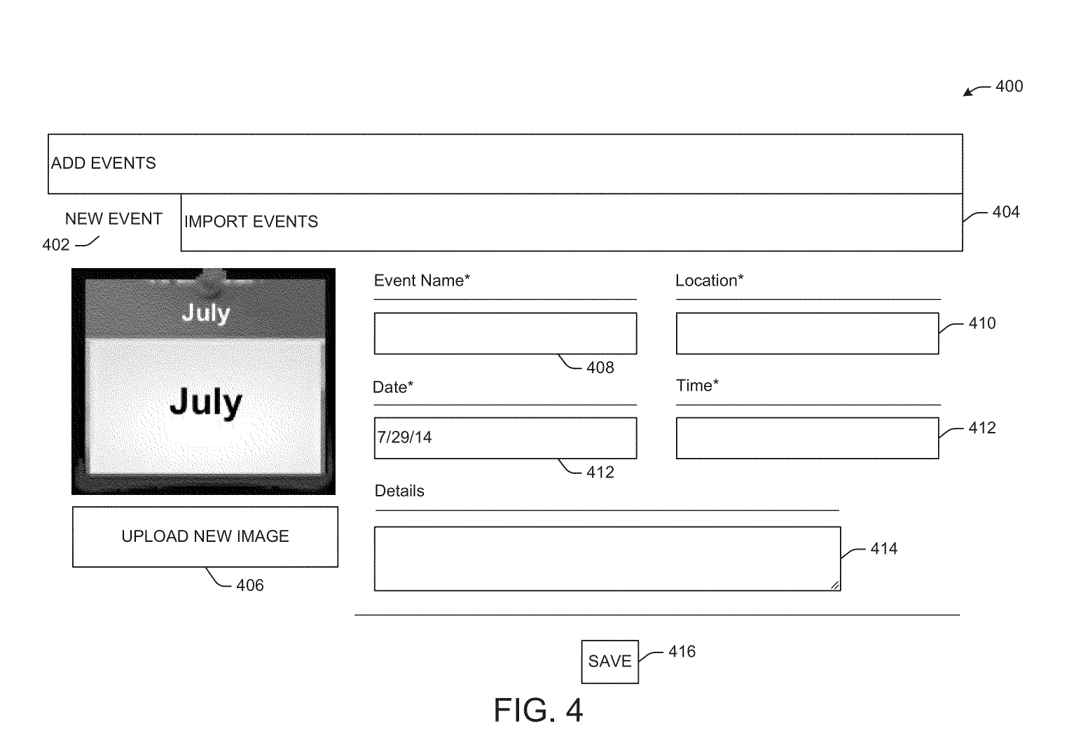

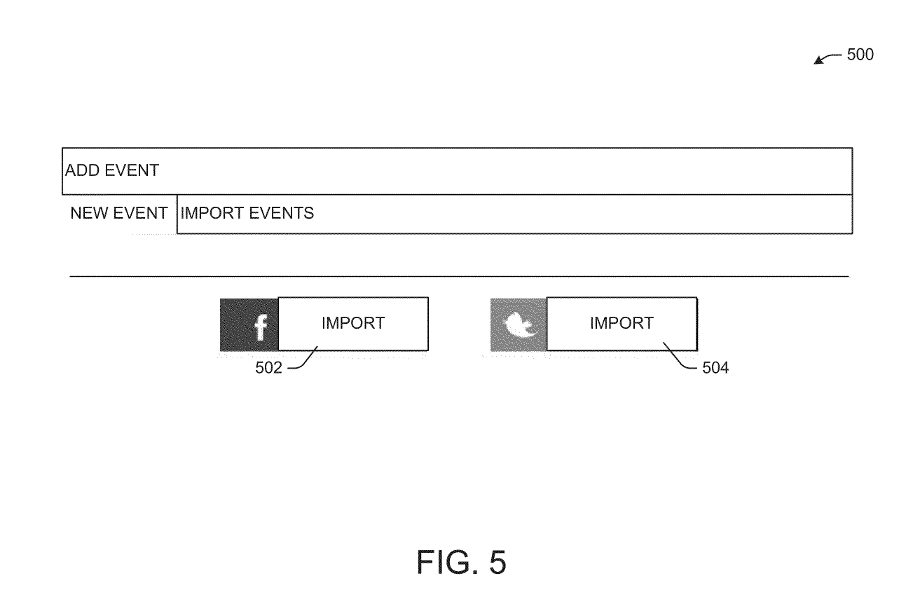

FIG. 4 illustrates an example implementation of a GUI 400 for adding a calendar event to a user account. As illustrated therein, a user may add information about a new event 402 by providing event information such as, for example, event name 408, event location 410, event date 412, event time 412, event details 414, personalized image 406, and save 416 this event information onto server 106, as described with reference to FIG. 1, for example. Alternatively, the user may import one or more events 404 from a third party website/server 114, 116, as described with reference to FIG. 1, for example. FIG. 5 illustrates an example implementation of a GUI 500 for importing events from a third party website/server 114, 116 such as, for example, Facebook 502 and Twitter 504.

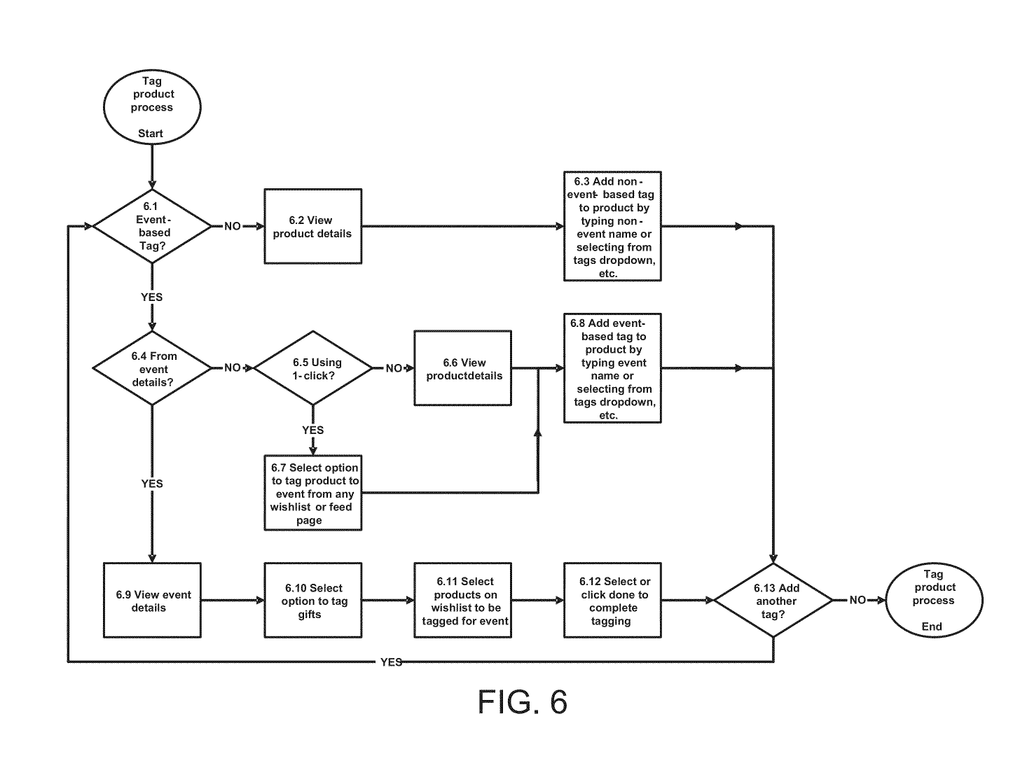

According to one or more example embodiments, gift receivers and gift givers leverage the features of the system described by the processes shown in FIGS. 6-14 to receive and give, respectively, the right gift for the right event. The system may connect gift receivers and givers to the retailers/merchants for the purposes of adding products to wishlists and purchasing products. The system also enables the retailers/merchants to leverage some of the system features to run advertising and promotional campaigns for their products, targeting select users, for example. All of the steps described herein may implemented by one or more data processors forming part of at least one computing system, or may be stored on a non-transitory computer program product storing instructions which, when executed by one or more data processors forming part of at least one computing system, result in operations described herein.

Turning now to FIG. 6, the creation of an event-based product tag may be driven first by user action. There may be various ways in which a user can tag a product to an event. The user can select the desired product to view its details and then select the option to add the event-based product tag to the product (6.1, 6.4-6.7), for example. Alternatively, the user can view the details of the event he/she created, select the option to tag gifts to the event, and then tag multiple products to the event at once from his/her wishlist (6.1, 6.4, 6.9-6.12), for example.

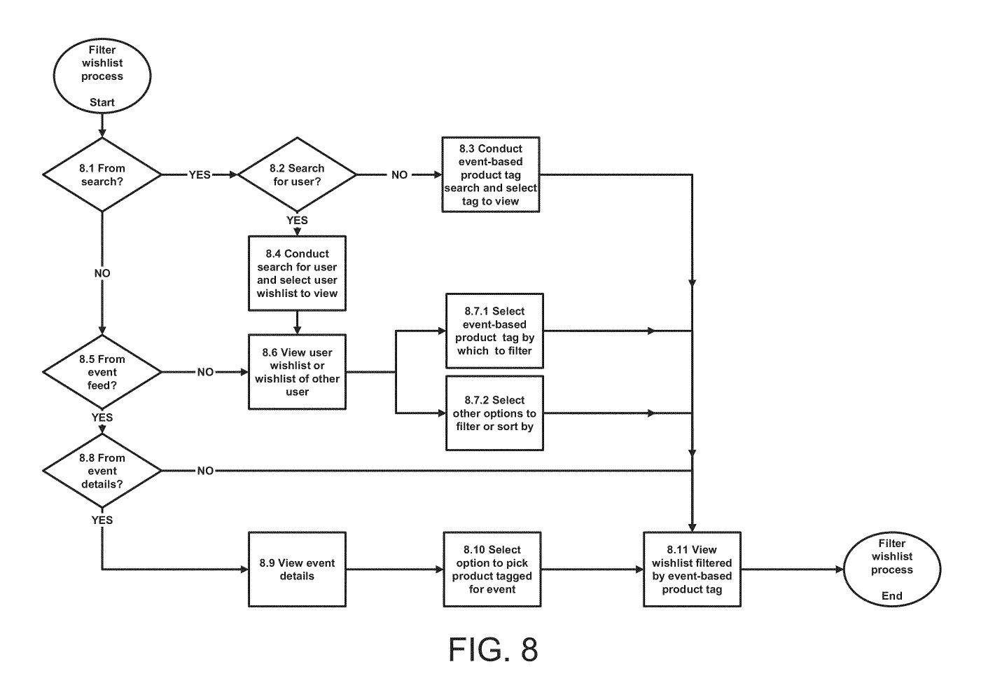

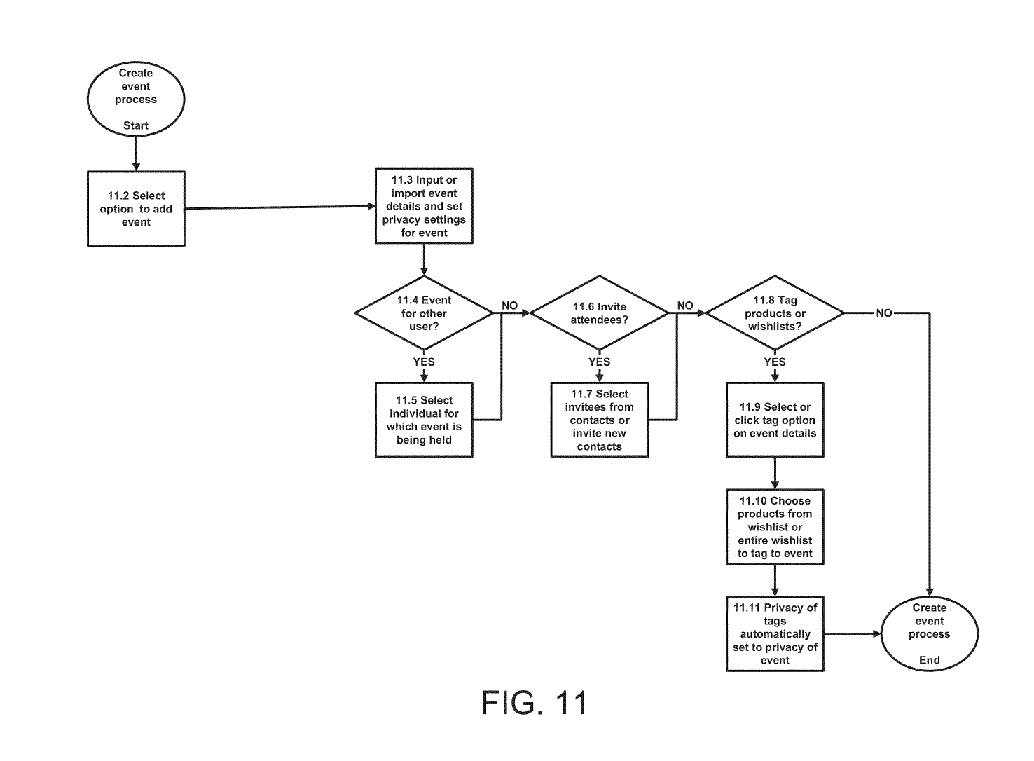

Once a tag has been added by the user, the information may be stored in the system databases for purposes of customizing the display of wishlist products for viewing by users. Filtering wishlists by event-based product tags, and setting privacy for event-based product tags (shown in FIGS. 8 and 11, respectively) provide more detail on the display customization.

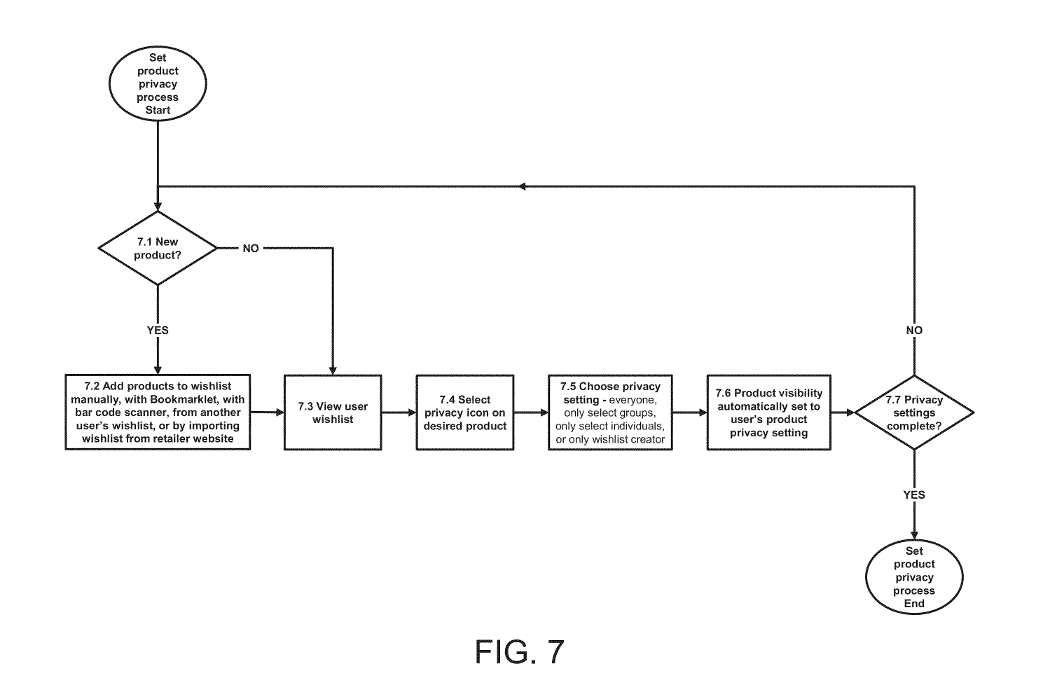

Moving now to FIG. 7, one or more example embodiments in the present disclosure may provide the user with tools necessary to have control over the privacy (or visibility) of each product. To set the privacy of a product (7.5), a user may select the product from his/her wishlist and choose a privacy settings, such as, Everyone (the product may be visible to everyone who is following the user), Only select groups (the user can share the product with one or more groups that he/she has created), Only select individuals (the user can share the product with one or more individuals who are following the user), or Private (the product is not shared with anyone and is only visible to the wishlist creator). The system then can adapt the visibility of the products to match the privacy criteria set by the user (7.6).

Turning now to FIG. 8, a user can filter his/her wishlist or the wishlist of another user by using event-based product tags, for example. There may be various ways in which a user can view event-based product tags and pick a product to gift for an event. For example, the first approach may be to select the wishlist of the event's host, and then to select the event-based product tag associated with the event. This may provide the user with a filtered view of the wishlist of the event's host, displaying all the products that have been tagged for the event. The user can then proceed to select a product to gift for the event (8.6, 8.7, 8.11). Alternatively, the user can select the event feed view and view the details of an event by selecting the event. Once in the event details view, the user can select the option to view all products associated with the event. As before, the user may be shown the wishlist of the event's host, filtered by the event-based product tag. The user can then select a product to gift for the event (8.8-8.11). Finally, the user also is provided the option to search for an individual or for a tag. If the user searches for an individual, he/she may select the individual from the search results page and proceed as mentioned above to filter the wishlist by the event-based product tag. If the user searches for a tag, he/she may be able to select the event-based product tag and may be shown the wishlist of the event's host, filtered by the tag (8.1-8.4, 8.11), for example.

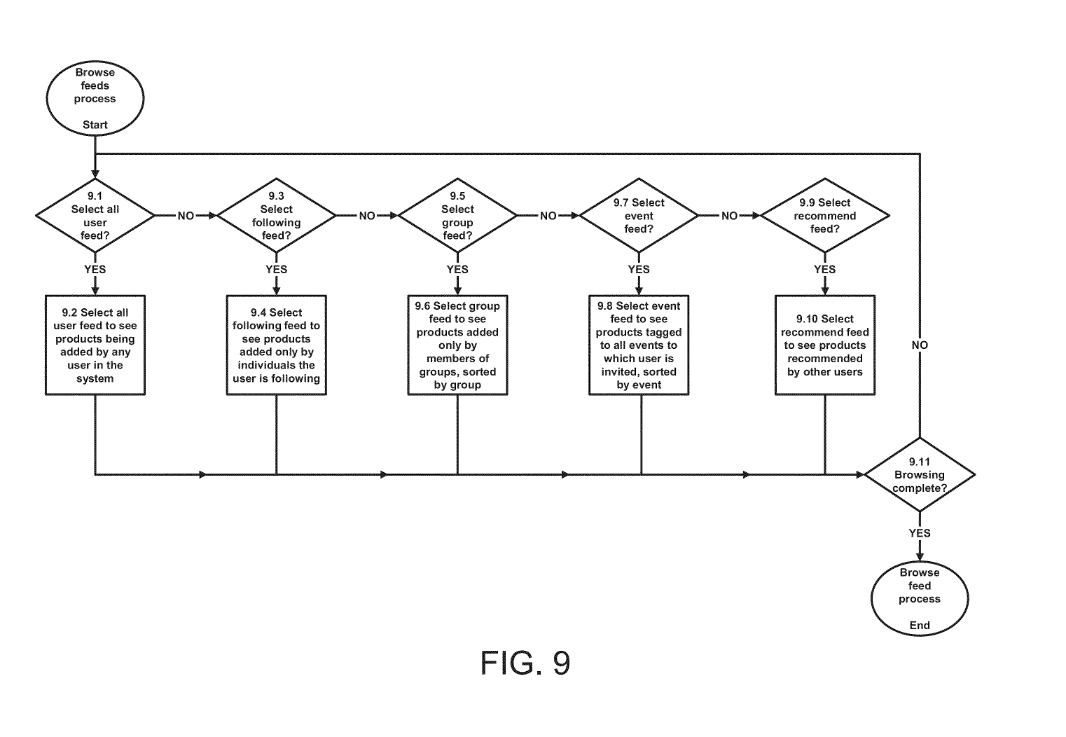

As illustrated in FIG. 9, for example, the system also provides a gift feed showing different views of the gift wishes being added to the system. The feed can be filtered by, for example, the “all user” feed, which displays products being added by any user in the system (9.1-9.2). The “following” feed displays products added only by individuals that the user is following (9.3-9.4). The “group” feed displays products added only by members of groups, sorted by group (9.5-9.6). The “event” feed displays products tagged to events to which the user is invited, sorted by event (9.7-9.8), for example. The “recommend” feed displays products recommended by other users to the user (9.9-9.10), for example.

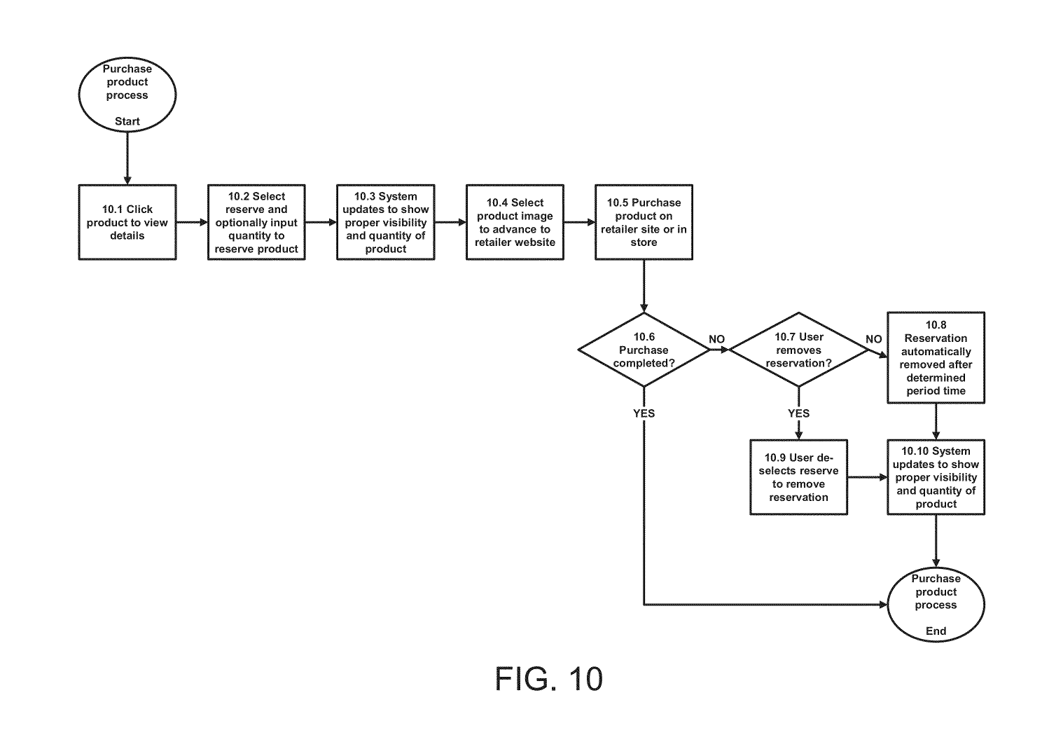

Moving now to FIG. 10, when a user selects a product from the gift feed or from the wishlist of a friend, he/she may have the option to reserve the product, up to the required quantity (10.1-10.2). The system may automatically update the quantity and re-compute the unfulfilled quantity for the product (10.3). If the desired quantity becomes zero, then the product is automatically disabled and other users may be prevented from gifting the same product to the same person using the system. Along the same lines, a user can remove the reservation of a product to again make it available to be gifted by other users (10.7, 10.9-10.10), for example. After a product is reserved, the gift giver proceeds to buying the product from the retailer/merchant (10.4-10.5). When a gift recipient marks the gift as “received,” for example, the gift giving & receiving transaction is complete and the system may archive it and display it in the gift giver's and recipient's profiles (12.1-12.5, 12.8). If a user reserves a gift but does not follow through on purchasing and actually gifting the product, the system may automatically clear the reservation and makes the product available to be gifted by other people (10.7-10.8, 10.10, 10.1, 10.6-10.8). This is one of the unique processes available only in this system.

According to one or more example embodiments, the system described herein provides a unique event management solution, as illustrated in FIG. 11, for example. Users are allowed to create events from scratch or import their already existing events from other websites such as Facebook, Twitter, Google etc. A user is allowed to import not only the events he/she created, but also the events to which he/she is invited (11.3). If the event is created using the described system, the user has the ability to invite friends and tag products to the event. The user simply selects the products that he/she desires for the event and the system automatically generates event-based product tags for all of the selected products (11.8-11.11). When an invitee views the event, he/she can also view the products associated (“tagged”) with the event by selecting the appropriate event-based product tag, which filters the wishlist created by the event's host (FIG. 8). Another unique aspect of the system described here is that it may allow a user to host events for other users. In this scenario, the event host may simply tag products from the wishlist of the user for whom the event is being hosted. Similarly, the event host may be able to invite friends from the friend list of the person for whom the event is being hosted. This approach simplifies the process of hosting an event for a friend (11.6-11.7). Another advantage of the system is that it provides the option of keeping event-based product tags private and only visible to the event's invitees. This prevents other contacts that are visiting the event host's profile from viewing products that are tagged for the event, or viewing the event and its details (11.3, 11.11).

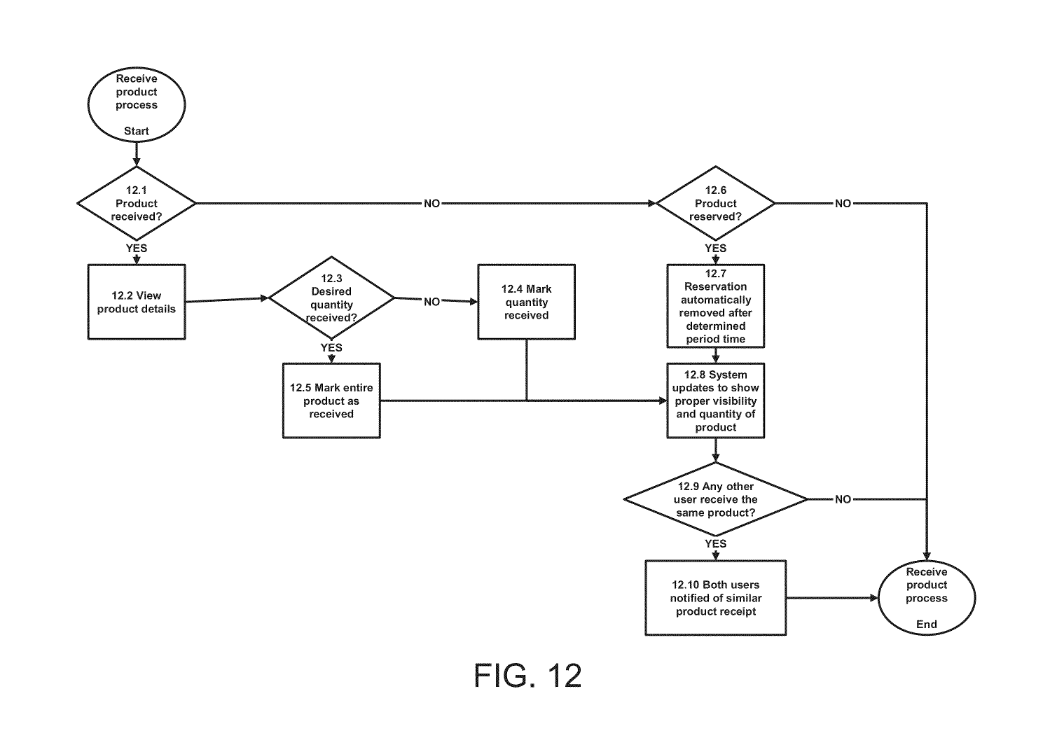

Turning now to FIG. 12, the process of a user gifting a product and the recipient marking the product as “received” is described in the following paragraphs (12.1-12.5, 12.6-12.8). An additional unique aspect of the present system is that when an individual marks a gift product as “received”, the system may automatically find other users inside and outside the individual's immediate circle of friends and display the following to all of the users who share the same gift. For example, a list of users who have received, purchased or want the same gift, or recommendations of complementary products or accessories that the other recipients of the same gift have purchased, received or want as gifts. This feature connects users who like the same type of products and enables them to share their experiences about the product with each other (12.9-12.10). According to one example embodiment, an application can be built as an extension of this idea to provide common services, such as technical support, service etc. to all users who like the same product(s).

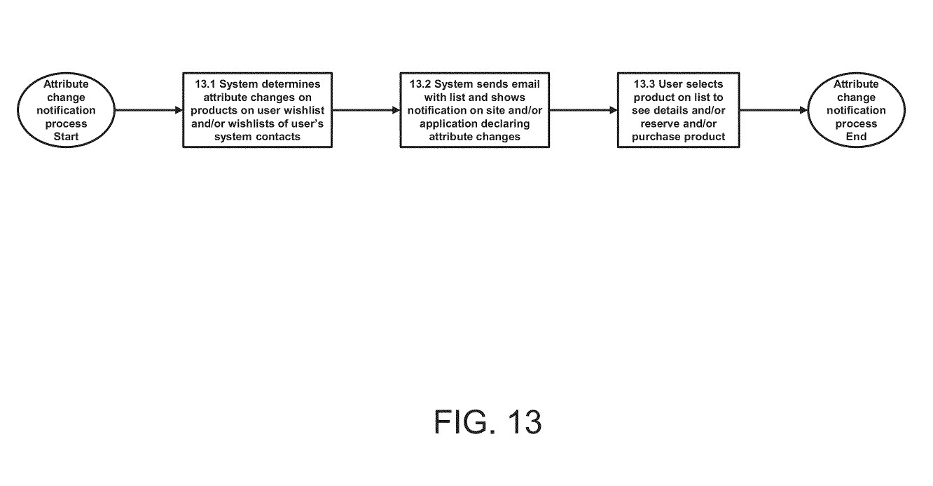

As illustrated in FIG. 13, for example, the system described herein may send notifications to users when an attribute of a wishlist product changes (13.1-13.3). Some examples include notifications on price changes—Users can be notified when the price of a product from a certain retailer changes by X % or $X, notifications on availability—Users can be notified when out-of-stock products become available, notifications on alternate vendors for a product—Users can be notified when the same or similar product is sold by another retailer, notifications on sales—A user can be notified of general sales promotions (e.g., coupons) from retailers whose product(s) are on the user's wishlist, for example.

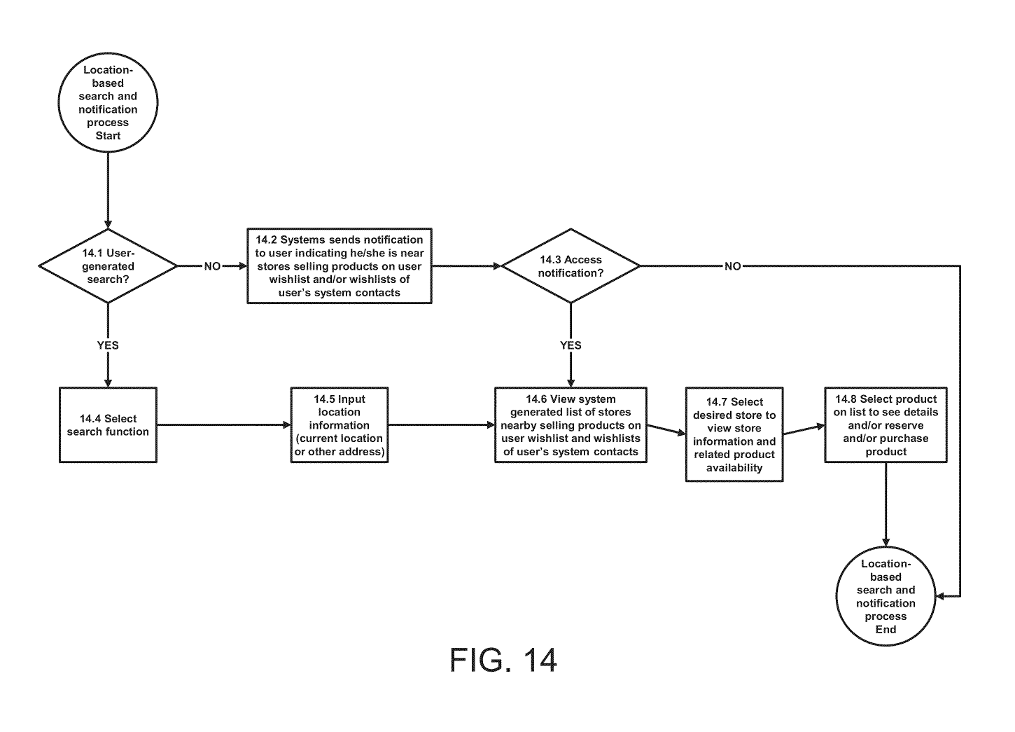

Moving now to FIG. 14, FIG. 14 illustrates an example method for carrying out a transaction according to one or more example embodiments of the present disclosure. Using a mobile platform such as a smart phone or a tablet with built-in geo-location tracking, a user can, for example, take advantage of location-based services offered by the described system. There are different ways in which a user can use location-based services and they are described below.

Searching for a specific product nearby—First, a user may enter his/her current location or enable automatic tracking of his/her current location. Next, the user may select a product from anywhere in our system, for example, from the gift feed, personal wishlist or a friend's wishlist. The system may then automatically display a list of nearby stores on a map that carry the product (14.1, 14.4-14.9), for example.

Searching for any product nearby—As mentioned above, the user would have to have his location tracking enabled. The user then selects the “find near me” option in the mobile application. The system may show a list of products that are on the wishlist of the user and his/her contacts, that are available nearby (14.1, 14.4-14.9).

“Push” notifications—If the user has enabled push notifications, he/she can get notified of an available product nearby. The user may have option to control the frequency of such notifications. For example, he/she might choose to get notified of only products which have been tagged for upcoming events (14.1-14.3, 14.7-14.9). In all of the cases described above, once a user selects a product from the locally available products list, he/she can reserve the product on the instant system and proceed to view the details and purchase the product in the physical or online store of the chosen retailer. It should be noted, however, that according to the example embodiments disclosed herein, the user selects an ‘instance’ of a product item from a merchant or seller to be included in his/her wishlist. For example, a user may pick an instance of an Xbox 360 on Bestbuy's website and add it to his/her wishlist. Alternatively, the user may select the product item itself to be included in his/her wishlist. For example, the user may just list an Xbox 360 on his/her wishlist, and it may be up to the giver to select a merchant/retailer who may sell that product for a cheaper price, such as for example, Amazon.

Example embodiments in the present disclosure are different and unique in that it supports wishlists that are designed to accommodate all life events and that can be shared with any other contact that has signed into the system. Instead of multiple registries or wishlists for multiple events, one wishlist can be used to manage multiple events by leveraging “event-based product tags”. Event-based product tags are identifying tags assigned to specific products by the host of the event. These tags are used to associate, i.e., connect, multiple events to the same product and multiple products to the same event. Therefore, a wishlist with event-based product tags allows users to only use one list and still maintain the ability to differentiate between events. To leverage event-based product tags, a user first creates events within the system and invites his/her contacts to the events or imports events from third-party event management websites such as Facebook. Then, the user is able to add event-based product tags to all of the user's events, and share those tags with his/her invitees to enable more efficient gift giving and receiving.

A wishlist managed within example embodiments in the present disclosure eliminates the redundancy of creating a separate registry or wishlist with the same products listed for each life event. Additional advantages of one or more example embodiments include setting privacy for event-based product tags, setting privacy for each product on a wishlist, filtering wishlists by event-based product tags, searching for event-based product tags, selectively sharing and displaying products for groups, indicating the unavailability of reserved products and automatically re-listing reserved products not received within a determined time period, using event-based product tags with events imported from external sources, providing third party event hosting using event-based product tags, connecting users who received the same gift, providing product attribute change notifications, and providing location-based gift search and notification. Thus, example embodiments in the present disclosure, for use on multiple computing devices, makes the gift giving and receiving process much simpler and improves on prior art.

One advantage of one or more example embodiments is that a wishlist with event-based product tags eliminates the redundancy of creating several registries or wishlists with the same products. Event-based product tags can be used to associate multiple events to the same product and multiple products to the same event. Therefore, a wishlist with event-based product tags allows users to only use one list and still maintain the ability to differentiate between events. Event-based product tags simplify the gift giving and receiving process.

Another advantage of one or more example embodiments is that event-based product tags may automatically be set to the privacy setting of an event. In other words, the event-based product tag may be visible to everyone or only event invitees depending on the privacy setting of the event.

Another advantage of one or more example embodiments is that it provides privacy settings for each product added to a wishlist. This feature allows the wishlist creator to share the products on his/her wishlist only with whom he/she wants to see those products. Conveniently, privacy can be set for viewing by everyone, only select groups, only select individuals, or only the wishlist creator. Therefore, the system provides customized presentation of any wishlist for any outside party that views it.

Another advantage of one or more example embodiments is that wishlist creators or viewers can filter a wishlist by event-based product tags. Filtering by event-based product tags allows the wishlist creator or viewer to quickly know exactly which products are associated with an event, thus making it very easy to find and purchase a gift. Users also have the ability to search for event-based product tags.

Another advantage of one or more example embodiments is the ability to share product with a group and view products on a group feed page. Consolidating the wishlists of a group of wishlist creators makes it very easy to quickly view what each person in that group wants for an event. For example, a family could host a group feed page to make it easy to get gifts for that family for Christmas.

Another advantage of one or more example embodiments is that wishlist viewers can reserve a product for purchase for the wishlist creator. Upon reservation, the product is displayed as unavailable to all wishlist viewers except the wishlist creator, for whom the product remains visually unchanged. Reservation reduces the likelihood of duplicate gifts while maintaining the element of surprise for the wishlist creator. Once a gift recipient receives the gift, he/she can mark that product in his/her wishlist as received. If a user reserves a gift and does not gift it to the intended person within a set amount of time (e.g., 30 days), the product may be automatically re-listed and may be made available to all wishlist viewers.

Another advantage of one or more example embodiments is that the system allows the user to add event-based product tags to not only events created within the system, but also events imported from external websites such as Facebook.

Another advantage of one or more example embodiments is that third parties may be able to host events and wishlists for other users. For example, a mother could host an event for her child by associating products from the child's wishlist with the event using an event-based product tag. This may have the effect of showing only products tagged to the event when an invitee views the mother's wishlist filtered by the event-based product tag.

Another advantage of one or more example embodiments is that it connects users who already own a gift to users who just received the same gift. Connecting users with the same gift may encourage usage, help with troubleshooting problems, and enable accessory recommendations.

Another advantage of one or more example embodiments is that it may provide product attribute change notifications should an attribute (price, promotions, availability, retailer location, etc.) of a wishlist product change. Product attribute change notifications may be customizable and used by registered users on the system to follow attribute changes of products on their own wishlist or on the wishlists of their contacts.

Another advantage of one or more example embodiments is that the system offers location-based search and notification services to those users using mobile computing devices. A user can search for or get notified of local pricing and availability information for gifts on his/her wishlist or his/her contacts' wishlists.

In summary, the system described makes giving and receiving the right gift for the right event easier and more efficient for users, without ruining a surprise. The system eliminates the need for redundant gift registries and provides a convenient way to manage gift products, events, and contacts.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Media suitable for embodying computer program instructions and data include all forms of volatile (e.g., random access memory) or non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other in a logical sense and typically interact through a communication network. The relationship of client and server arises by virtue of computer programs running on the respective computers and having a client-server relationship to each other.

The subject matter described herein has been described in terms of particular embodiments, but other embodiments can be implemented and are within the scope of the following claims. For example, operations can differ and still achieve desirable results. In certain implementations, multitasking and parallel processing may be preferable. Other embodiments are within the scope of the following claims.

1. A method for implementation by one or more data processors forming part of at least one computing system, the method comprising:
creating a wishlist comprising one or more product items;
creating or importing, from a third-party server, one or more calendar events;
associating the one or more product items with at least one of the one or more calendar events, or associating the one or more calendar events with at least one of the one or more product items.

2. The method of claim 1, further comprising associating two or more product items with at least one of the one or more calendar events, or associating two or more calendar events with at least one of the one or more product items.

3. The method of claim 1, further comprising creating a privacy setting for the one or more product items on the wishlist based, at least in part, on the one or more calendar events.

4. The method of claim 3, wherein the one or products items on the wishlist is visible to everyone, only individuals invited to the one or more calendar events, one or more select individuals, one or more select groups, or only the creator of the wishlist.

5. The method of claim 3, further comprising tagging the one or more products using a tag.

6. The method of claim 5, wherein the one or more product items are configured to be filtered by event, by tag, by privacy setting, and sorted by popularity, price, date or promotions.

7. The method claim 1, wherein if the one or more calendar events are imported from the social networking service, then an attendee list comprising at least a portion of the attendees to the one or more calendar events imported is generated.

8. The method of claim 1, further comprising providing location-based search and notification services for the one or more product items on any wishlist in the user's network.

9. The method of claim 1, further comprising providing a product item attribute change notification to a user when a product item attribute comprising price, promotion, availability, or retailer location changes or the event associated with the product item changes, or the product item is removed from the wishlist.

10. The method of claim 1, further comprising inviting one or more friends to the one or more calendar events.

11. The method of claim 1, further comprising connecting users who recently received a gift to users who already own the gift.

12. The method of claim 1, wherein the one or more product items are curated products.

13. The method of claim 1, further comprising reserving the one or more product items on the wishlist.

14. The method of claim 13, further comprising indicating unavailability of the reserved product items, and re-listing the reserved product items not purchased within a determined period of time.

15. The method of claim 1, further comprising removing a product item from the wishlist upon purchase of the product item.

16. The method of claim 1, wherein the wishlist is created by adding the one ore more product items to the wishlist manually, using a web widget, using a bar code scanner, from another user's wishlist, or by importing at least part of the wishlist from a retailer's website.

17. A non-transitory computer program product storing instructions which, when executed by one or more data processors forming part of at least one computing system, result in operations comprising:
creating a wishlist comprising one or more product items;
creating or importing, from a third party server, one or more calendar events;
associating the one or more product items with at least one of the one or more calendar events, or associating the one or more calendar events with at least one of the one or more product items.

18. The computer program product of claim 17, further comprising associating two or more product items with at least one of the one or more calendar events, or associating two or more calendar events with at least one of the one or more product items.

19. The computer program product of claim 17, further comprising creating a privacy setting for the one or more product items on the wishlist based, at least in part, on the one or more calendar events.

20. A system for event-based gift giving and receiving, the system comprising:
means for creating a wishlist comprising one or more product items;
means for creating or importing, from a third party server, one or more calendar events;
means for associating the one or more product items with at least one of the one or more calendar events, or associating the one or more calendar events with at least one of the one or more product items.
